(19) United States
(12) Patent Application Publication
(10) Pub. No.: US 2005/0086937 A1
(43) Pub. Date: Apr. 28, 2005

(54) Combined solar and wind powered rotor mechanism

(76) Inventor: George R. Royer, Toledo, OH (US)

Correspondence Address: George R. Royer, Suite 416, 316 N. Michigan Street, Toledo, OH, 43624, US

(21) Appl. No.: 10/694,701

(22) Filed: Oct. 27, 2003

(51) Int. Cl. B60K 16/00; F03G 6/00; B60L 8/00

(52) U.S. Cl. 60/641.8

(57) ABSTRACT

The subject apparatus which incorporates features of the subject invention is a combined wind powered and solar powered rotor mechanism, specifically utilizing energy from both solar and wind sources to provide energy to drive a rotor mechanism, such apparatus comprising in its general form a vertically standing or substantially upright structure that has an air intake opening at the bottom portion or at some position intermediate between the bottom portion and upper portion of the apparatus, such opening connecting outside air with a central longitudinally extending chamber that extends upwardly towards the upper part of the apparatus, with a portion of the apparatus, in one embodiment, being comprised of translucent material to admit solar energy into the longitudinal extending chamber with a portion of the chamber, in one embodiment, being formed of solar absorption materials to receive solar energy, with an air powered rotor mechanism at or near the upper portion of the chamber, such rotor mechanism having a central rotational axle rotationally installed through or adjacent to such chamber, such rotational axle having air movement sensitive means to receive the impact of any upwardly extending air moving through such chamber and additionally having air movement sensitive means disposed on a portion of such rotational axle to receive directly air from outside such chamber, for direct rotational drive of such rotational axle.

### KNOWN PRIOR ART

There are several known devices that utilize solar generated heat.

### DISCUSSION OF PRIOR ART AND BACKGROUND OF INVENTION

Energy conversion devices can potentially utilize both solar and wind to drive a rotor mechanism for ultimate energy generated for usage in mechanical, electrical or other form. Devices incorporating features using solar energy indirectly and direct wind power to drive a rotor mechanism would be economical and environmentally harmless, specifically using both wind and solar energy.

More directly means to combine the driving force of both air movement and solar heat so that both such energy sources are utilized directly or indirectly to drive a rotor or similar such mechanism would augment energy output. In this area of energy conversion, there are no effective devices structured to alternately and simultaneously capture solar energy and wind energy as distinct and separate driving forces so as to capitalize on both such energy sources to drive a common separate rotor mechanisms, thereby increasing the energy output productivity of the apparatus. The concept of using, in an apparatus, wind power alone to drive a rotor in the absence of any available sunlight and conversely if no wind is available solar energy can be captured to drive the mechanism.

In view of the above the following objects as set forth below:

In summary and in general the subject invention is based around a base member generally of upright disposition and having a hollow internal chamber with an air inlet opening to admit air into such chamber and an air movement powered base rotor located either in such chamber or outside such chamber, with the rotor blades of such bases rotor being positioned to receive any upward air movements through such chamber so as to rotate such base rotor around its longitudinal central axis.

More directly, the subject apparatus is generally adapted to have means therein to admit outside air into the chamber so that the solar heat generated in the chamber will help accelerate through convection mean or otherwise to move such air admitted into the chamber to facilitate and increase the speed of the admitted air into the chamber and thence out of the air outlet opening onto the rotor blades.

### OBJECTS OF INVENTION

It is an object of the subject invention to provide an improved energy conversion device, using both solar and wind power;
Yet another object of the subject invention is to provide improved environmentally sound energy conversion device that is relatively pollution free;
Another object of the subject invention is to provide an improved apparatus to capture simultaneously or separately both solar power and wind power for ultimate usage or to capture such diverse power sources on an alternate basis, dependent on existing climatic conditions;
Still another object of the subjection invention is to provide a relatively efficient energy source;
A further object of the subject invention is to provide an improved device for using solar and wind power sources;
It is also an object of the subject invention to provide an improved energy conversion mechanism;
Other objects of the subject invention will become apparent from a reading of the description taken in conjunction with the claims.

### BRIEF DESCRIPTION OF THE DRAWINGS

FIG. 1 is a front planar view of the subject invention;

FIG. 2 is a side elevational view of the subject invention shown in cross sectional configurations;

FIG. 3 is a perspective view of the subject invention shown partially cut away on the frontal part;

FIG. 4 is a front elevational view of the subject invention; in section, showing an alternate embodiment of the subject invention.

### DESCRIPTION OF GENERAL EMBODIMENT

The subject apparatus which incorporates features of the subject invention is a combined wind powered and solar powered rotor mechanism, specifically utilizing energy from both solar and wind sources to provide energy to drive a rotor mechanism, such apparatus comprising in its general form a vertically standing or substantially upright housing structure that has an air intake opening at the bottom portion or at some position intermediate between the bottom portion and upper portion of the apparatus, such opening connecting outside air with a central longitudinally extending chamber in such housing structure that extends upwardly towards the upper part of the apparatus, with a portion of the apparatus being comprised of translucent material to admit sun light into the longitudinal extending chamber with a portion of the chamber being formed of solar absorption materials to receive solar energy from such sun light, with an air driven rotor mechanism at or near the upper portion of the chamber, such rotor mechanism having a central rotational axle rotationally installed through or adjacent to such chamber, such rotational axle having air movement sensitive means to receive the impact of any upwardly extending air moving through such chamber and wherein such rotational axle additionally having air movement sensitive means disposed on a portion of such rotational axle to receive directly air from outside such chamber, for driving such rotational axle.

Alternately stated, the subject apparatus which incorporates features of the subject invention is a combined wind powered and solar powered rotor mechanism, specifically utilizing either directly or indirectly energy from both solar and wind sources to provide energy to drive a rotor mechanism such apparatus comprising in its general form a vertically standing or substantially upright structure that has an air intake opening at the bottom portion or at some position intermediate between the bottom portion and upper portion of the apparatus, such opening connecting outside air with a central longitudinally extending chamber that extends upwardly towards the upper part of the apparatus towards an air opening, with a portion of the apparatus being comprised of translucent material to admit solar energy into the longitudinal extending chamber with a portion of the chamber being formed of solar absorption materials to receive solar energy, with an air powered rotor mechanism at or near the upper portion of the chamber, such rotor mechanism having a central rotational axle rotationally installed at or near the upper portion of such longitudinally extending chamber such rotational axle having air movement sensitive blades inside or outside the upper portion of such longitudinally extending chamber.

In summary and in general, the subject invention is based around a base member generally of upright disposition and having a hollow internal chamber with an air inlet opening to admit air into such chamber and an air movement powered base rotor located either in such chamber or outside such chamber, with the rotor blades of such bases rotor being positioned to receive any upward air movements through such chamber so as to rotate such base rotor around its longitudinal central axis.

More directly, the subject apparatus is generally adapted to have means therein to admit outside air into the chamber so that the solar heat generated in the chamber will help accelerate through convection means or otherwise to move such air admitted into the chamber to facilitate and increase the speed of the admitted air into the chamber and thence out of the air outlet opening onto the rotor blades.

In one of several alternate structural arrangements of such device, the subject invention may have separate rotor means affixed on an independent or secondary rotor aside from the base rotor or affixed on a different portion of the base rotor. This separate or secondary rotor means is also structured to and positioned to receive wind forces flowing from air outside the chamber against such secondary rotor means. Thus, head-on air currents from the outside drive the secondary rotor or base rotor, while air movements inside the chamber drive the rotor separately thereby producing dual drive forces on the rotor.

### DESCRIPTION OF A SPECIFIC EMBODIMENT OF SUBJECT INVENTION

The following description of one specific embodiment and shall not be construed to limit the scope of the claims annexed hereto, as other embodiments may be considered to be in the scope of the invention herein. Therefore the following description will not be construed by limiting the scope of the claims hereto.

The subject apparatus which incorporates features of the subject invention is a combined wind powered and solar powered rotor mechanism, specifically utilizing energy from both solar and wind sources to provide energy to drive a rotor mechanism, such apparatus comprising in its general form a vertically standing or substantially upright housing structure that has an air intake opening at the bottom portion or at some position intermediate between the bottom portion and upper portion of the apparatus, such opening connecting outside air with a central longitudinally extending chamber in such housing structure that extends upwardly towards the upper part of the apparatus, with a portion of the apparatus being comprised of translucent material to admit sun light into the longitudinal extending chamber with a portion of the chamber being formed of solar absorption materials to receive solar energy from such sun light, with an air driven rotor mechanism at or near the upper portion of the chamber, such rotor mechanism having a central rotational axle rotationally installed through or adjacent to such chamber, such rotational axle having air movement sensitive means to receive the impact of any upwardly extending air moving through such chamber and wherein such rotational axle additionally having air movement sensitive means disposed on a portion of such rotational axle to receive directly air from outside such chamber, for driving such rotational axle.

Alternately stated, the subject apparatus which incorporates features of the subject invention is a combined wind powered and solar powered rotor mechanism, specifically utilizing either directly or indirectly energy from both solar and wind sources to provide energy to drive a rotor mechanism, such apparatus comprising in its general form a vertically standing or substantially upright structure that has an air intake opening at the bottom portion or at some position intermediate between the bottom portion and upper portion of the apparatus, such opening connecting outside air with a central longitudinally extending chamber that extends upwardly towards the upper part of the apparatus towards an air opening, with a portion of the apparatus being comprised of translucent material to admit solar energy into the longitudinal extending chamber with a portion of the chamber being formed of solar absorption materials to receive solar energy, with an air powered rotor mechanism at or near the upper portion of the chamber, such rotor mechanism having a central rotational axle rotationally installed at or near the upper portion of such longitudinally extending chamber such rotational axle having air movement sensitive blades inside or outside the upper portion of such longitudinally extending chamber.

In summary and in general, the subject invention is based around a base member generally of upright disposition and having a hollow internal chamber with an air inlet opening to admit air into such chamber and an air movement powered base rotor located either in such chamber or outside such chamber, with the rotor blades of such bases rotor being positioned to receive any upward air movements through such chamber so as to rotate such base rotor around its longitudinal central axis.

More directly, the subject apparatus is generally adapted to have means therein to admit outside air into the chamber so that the solar heat generated in the chamber will help accelerate through convection means or otherwise to move such air admitted into the chamber and thence out of the air outlet opening to facilitate and increase the speed of the admitted air into the chamber onto the rotor blades.

In an alternate structural arrangement of such device, the subject invention may have separate rotor means affixed on an independent or secondary rotor aside from the base rotor or affixed on a different portion of the base rotor. This separate or secondary rotor means is also structured to and positioned to receive wind forces flowing from air outside the chamber against such secondary rotor means. Thus, head-on air currents from the outside drive the secondary rotor or base rotor, while air movements inside the chamber drive the rotor separately thereby producing dual drive forces on the rotor.

In yet another embodiment of the subject invention, the solar absorption portion in the internal chamber of the device may be interconnected to electrical conversion means to transfer heat energy to electrical energy to supplement the energy output of the device.

The subject apparatus which incorporates features of the subject invention is a combined wind powered and solar powered energy conversion mechanism, specifically utilizing energy from both solar and wind sources to provide energy to ultimately drive a rotor mechanism, such apparatus comprising in its general form a vertically standing or substantially upright structure that has an air intake opening at the bottom portion or at some position intermediate between the bottom portion and upper portion of the apparatus, such opening connecting outside air with a central longitudinally extending chamber that extends upwardly towards the upper part of the apparatus, with a portion of the apparatus, in one embodiment, being comprised of translucent material to admit solar energy into the longitudinal extending chamber with a portion of the internal chamber, in one embodiment, being formed of solar absorption materials to receive solar energy, with an air powered rotor mechanism at or near the upper portion of the chamber, such rotor mechanism having a central rotational axle rotationally installed through or adjacent to an air outlet opening on such chamber, such rotational axle having air movement sensitive means to receive the impact of any upwardly extending air through such chamber and additionally having air movement sensitive means disposed on a portion of such rotational axle to help drive such rotor upon receiving head-on air movement from outside such chamber.

The subject apparatus which incorporates features of the subject invention is a combined wind powered and solar powered rotor mechanism, specifically utilizing energy from both solar and wind sources to provide energy to drive a rotor mechanism, such apparatus comprising in its general form a vertically standing or substantially upright structure that has an air intake opening at the bottom portion or at some position intermediate between the bottom portion and upper portion of the apparatus, such opening connecting outside air with a central longitudinally extending chamber that extends upwardly towards the upper part of the apparatus, with a portion of the apparatus being comprised of translucent material to admit solar energy into the longitudinal extending chamber with a portion of the chamber being formed of solar absorption materials to receive solar energy, with an air powered movement rotor mechanism at or near the upper portion of the chamber and preferably near the outlet opening of such chamber, such rotor mechanism having a central rotational axle rotably installed at or near the upper portion of such longitudinally extending chamber adapted to receive solar heated air flowing upwardly and outwardly from said chamber, such rotatable axle having air movement sensitive blades fully inside partially inside or completely or partially outside the upper portion of such longitudinally extending chamber, or which may be disposed in any other appropriate manner to receive the impact of such air flowing out of the chamber.

In summary and in general, the subject invention is based around a base member generally of upright disposition having a hollow internal chamber with an air inlet opening to admit air into such chamber and an air movement powered base rotor located either in such chamber or outside such chamber, with the rotor blades of such rotor being positioned to receive any upward air movements through such chamber through such air outlet opening so as to rotate such base rotor along its longitudinal central axis.

More directly, the subject apparatus is generally adapted to have means therein to admit outside air into the chamber so that the solar heat generated in the chamber will help accelerate, through convection means or otherwise, and move upwardly such air admitted into the chamber to facilitate and increase the speed of the admitted air into the chamber onto the rotor blades.

In one of several alternate structural arrangement of such device, the subject invention may have separate rotor means affixed on an independent or secondary rotor aside from the base rotor or affixed on a different portion of the base rotor. This separate or secondary rotor means is structured to and positioned to receive wind forces flowing from air outside the chamber against such secondary rotor means. Thus, air currents from the outside drive the base rotor or a separate rotor, while air movements emanating from inside the chamber drive the rotor separately or another rotor thereby producing a separate drive force on the rotor.

In the specific embodiment described herein, the rotor blades or rotor drive means on the base rotor are situated to receive moving air up through such chamber and may be positioned in such a manner so that such rotor blade means may also be concurrently driven in a rotational manner by ambient air flow impinging directly head-on additional rotor means from air outside the chamber flowing generally head-on against such rotor.

For a description of one specific embodiment of the subject invention, among several, attention is directed to the drawings in which a solar-wind energy conversion base structure 10 is shown. Energy conversion base structure 10 is preferably, but not essentially, an upright structure comprising a housing 20 that has a lower end 30 and an upper end 40. The housing 20 contains inside such housing proper an internal longitudinally extending spatial hollow chamber 50 that in the specific embodiment is vertically disposed and is preferably but not essentially aligned along the longitudinal vertically extending central axis of the housing 20.

In such embodiment, it is not critical that the hollow chamber 50 be longitudinally extending or vertically extending or be in any symmetrical form or that the chamber 50 be aligned with the vertical longitudinal central axis of the housing as that the housing itself be aligned vertically or upright. Housing 20 has a front surface 60 and a back surface 70, and lateral sides 80A and 80B and a lower surface 85A and an upper surface 85B. At or near the lower portion of the front surface 60 is an air intake opening 90 which is adapted to draw in air currents from areas outside housing 20 arriving at or near the lower end 30 of the housing 20. It is to be stated that the air intake opening 90 can be located at any position on the housing 20 and not necessarily near or adjacent to the bottom thereof. It is preferable that the front surface 60 of housing between lucent to permit sunlight to penetrate directly into housing 50 for solar heating purposes.

It is stressed that the base structure 10 formed essentially as a housing, as set forth above, may be structured otherwise than as set forth in the above described preferred embodiments. More directly, the base structure 10 need not be constructed as a longitudinally extending member, nor need it be rectangular or parallelepiped in shape as seen from the front or in other positional views. Moreover, the base structure 10 need not be vertically upright as portrayed and it is not essential or critical that the air intake opening 90 be at lower end of the housing 20. The housing may be any configuration from any viewpoint and the internal hollow chamber in to the housing 20 need not be structured in the form shown and described.

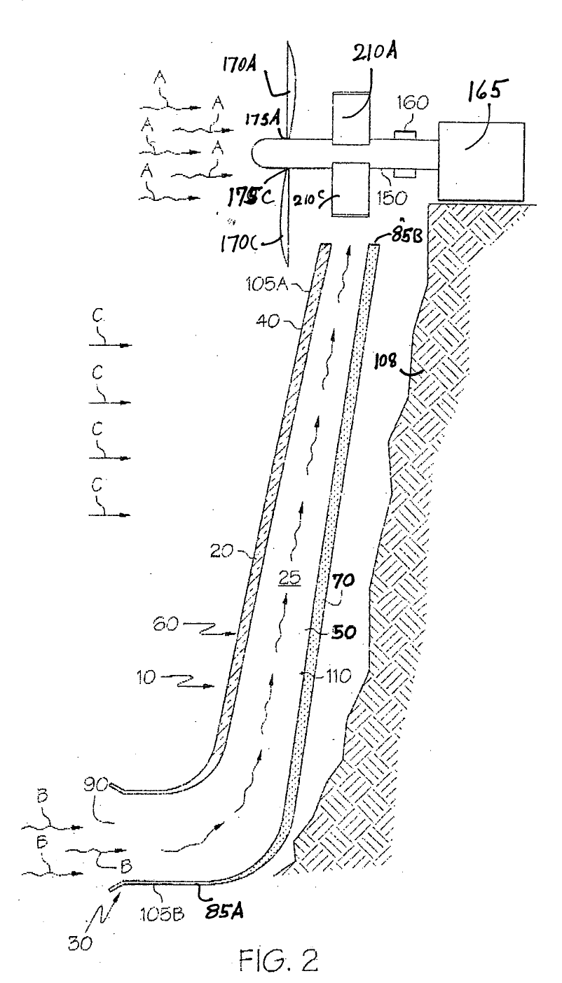

In the specific embodiment set forth above, the hollow chamber 50 is substantially enclosed except for an air intake opening 90 at or near the lower end 30 of the housing 20, which air intake opening 90 is open to and otherwise preferably, but not essentially, faces forward from the frontal surface 60 optimally facing towards the prevailing windflow patterns, as particularly seen in FIG. 2. Moreover, it is preferable that the front surface 60 of the base structure 10 be positioned to face a direction to receive sun light during a portion of the day, as more fully described and comprehended below. Moreover, in some circumstances it may be optimal to position the base structure 10 in a substantially upright position along the side of a mountain, hill or cliff 108 as graphically represented in FIG. 2. The reason for such position is to take advantage of the usual upward flow of winds or air currents up the side of a mountain during day time hours.

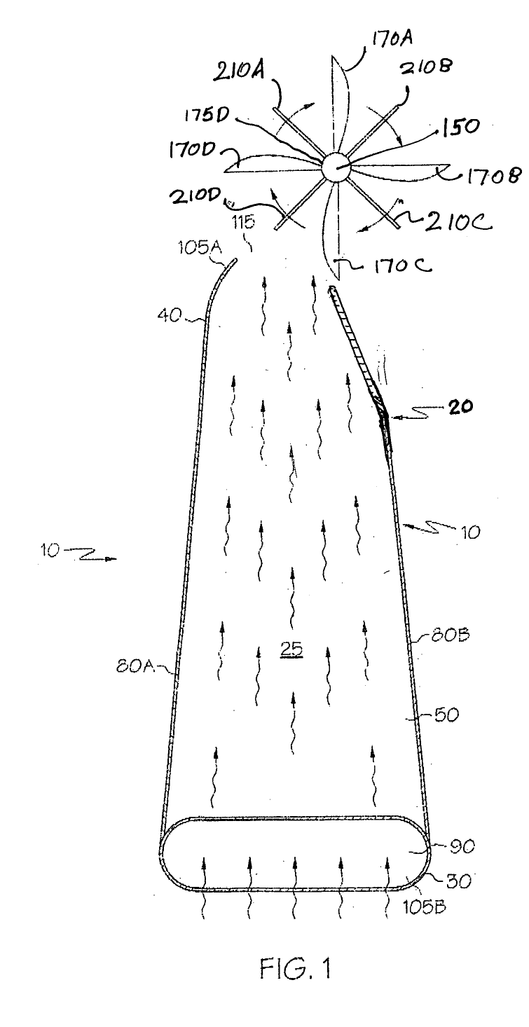

Thus, from the above description and as can be seen from the drawings, the internal hollow chamber 50 is structured and formed by the front surface 60, the rear surface 70 and the sides 80A and 80B, enclosed upper surface 85B and lower surface 85A and 105B of housing 20 respectively, and is exposed to outside air through air inlet opening 90, as seen, which air inlet opening is adapted to feed air into the lower part of the hollow chamber 50, as shown schematically in FIGS. 1 and 2.

For the purpose of implementing the preferred embodiment, the front surface 60 of housing 20 should optimally be comprised of a translucent material in order to permit solar rays to pass through such front surface into the hollow chamber 50 for solar heating of the air inside the chamber 50. For purposes of facilitating the solar heating of the incoming ambient air inside the hollow chamber 50, it is preferable, but not critical, to have the frontal surface area 110 of the rear portion 70 of the housing 20, comprised painted or coated with a solar absorption material such as black paint. This solar heat absorption will function to retain heat and help generate more heat as it absorbs sunlight to the ambient air as it rises upwardly in the hollow chamber 50, thus providing a greater velocity to the upward flow of air.

In constructing the specific embodiment, the hollow chamber 50 in housing 20 may be, but not necessarily gradually tapered to a smaller perimeter or spatial size as it extends upwardly from the air intake opening 90 to the upper portion of the chamber 50, as can be seen in the drawings. This tapering effect also helps to channel moving air upwards into a gradually restricted area to move such rising air with greater velocity. At or near the upper end of the housing 30 is the air outlet opening 115, which latter opening is structured to emit the rising air from the upper part of the enclosed chamber 50, as demonstrated schematically in FIGS. 1 and 2. The air outlet opening 115 can be positioned at any portion of the housing 20, however.

Affixed and supported above housing member 20 is a rotor shaft member 150 that preferably projects directly and frontally towards the front surface portion 60 of the housing, and thus, specifically extends frontwardly generally perpendicularly to the front surface portion 60 of the housing and facing preferably towards the area of any prevailing winds. The rotor shaft member 150 can be mounted through a bearing surface element 160 so that when the rotor shaft rotates, it will rotate about such fixed bearing surface. Bearing element 160 can be affixed to the housing or on other nearby structures. The rotor shaft 150 can be thence interconnected to a generator 165 powered by the rotational movement of rotor 160.

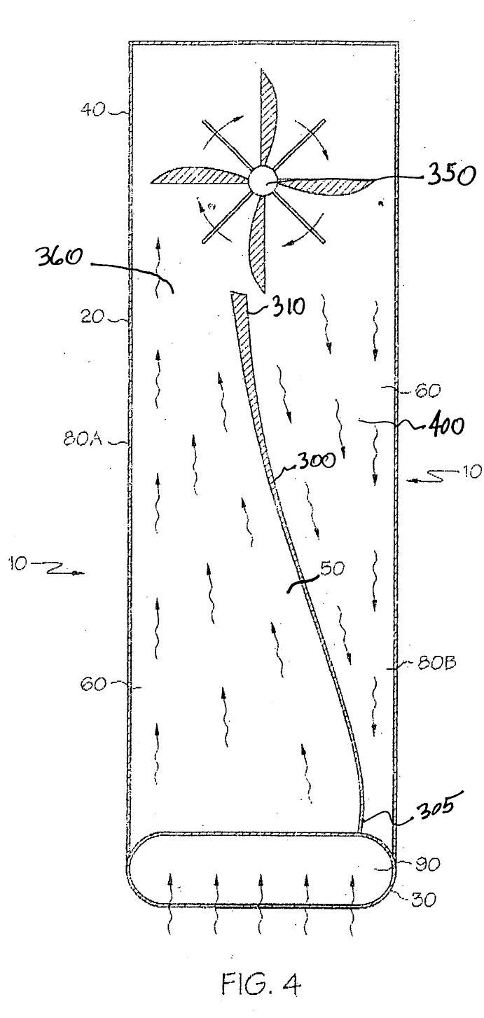

In the specific described embodiment herein the rotor shaft 150 is mounted above the housing 20 so that there is sufficient open space for the direct oncoming wind at the upper level of housing 30 to effectively drive the rotor without encountering eddy current effects interfering with such air flow. However, in some embodiment the rotor shaft 160 can be mounted within the housing 20, as seen in FIG. 4, or above or in front of such housing or in other positions. In any structural circumstances, the front portion of the rotor member 150 may be face frontally, as stated with the frontal portion of the rotor member 150 preferably extending outward away from the housing or beyond the front surface 60 of the housing 20 and preferably has multiple turbine blades 170A, 170B, 170C and 170D for receiving the impact of winds in the air outside housing 20 to drive the rotor 150 independently of any air movement forces generated within housing 20. However, the number of turbine blades deployed on the rotor member 150 is optional.

The radially inner portions 175A, 175B, 175C and 175D respectively of rotor blades 170A, 170B, 170C and 170D are affixed in a radially-spaced manner on the outer surface of the rotor shaft to create a symmetrical arrangement of spacing of such rotor blades. This latter aspect is not critical to implementation of the subject invention Thus, as seen in FIGS. 1, 2 and 3 of the drawings, the rotor shaft 150 is mounted just above the upper portion of housing 20, inside or outside of the hollow chamber 50 at an area where the housing portion is more narrow when viewed in a frontal view. Moreover, as the rotor shaft 150 preferably extends above and outwardly from the housing 20, it is essential that the rotor blades clear the housing for free rotational movement.

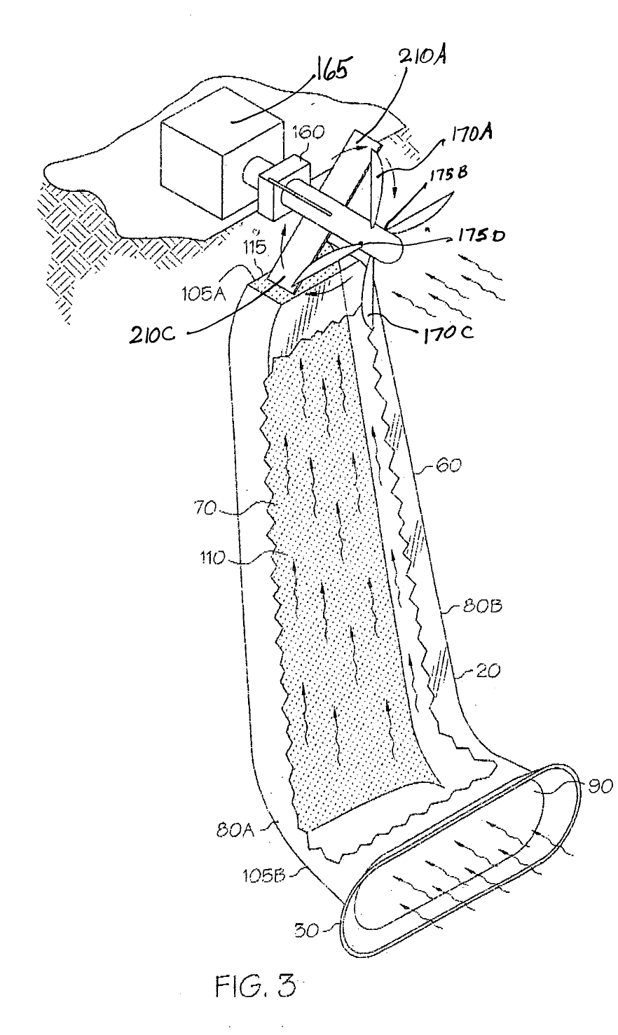

As seen in the frontal elevational view as shown in FIG. 1, the housing 20 with it longitudinally extending hollow chamber 50 with the lower end 85B and upper end 85A thereof disposed or otherwise positioned in a substantially vertically upright position the lower end 180 of the chamber 50 is generally the area where the air intake opening 90 is located. In structure, the described arrangement as seen in FIG. 3 is a hollow chamber 50 preferably and ideally, but not essentially, will extend over almost the full width of the lower end 85B of the housing 20. By this latter arrangement the air intake opening 90 should extend over the entire width of the lower end 180 of the chamber 50 as it leads into and fully communicates spatially with the lower end of the chamber 50. In other words, the spatial area of the chamber 50 at the lower end 180 thereof should ideally, but not substantially, be substantially equal to the width of the air intake opening 90 at the area where such air inlet opening extends into the hollow chamber 50. This will enable the lower end 180 of hollow chamber 50 to receive the full impact of the air flow into and from the air inlet opening 90 without hindrance.

As further can be observed from a view of the drawings, particularly FIGS. 1 and 2, hollow chamber 50 is preferably structured to be progressively narrowed as it extends upwardly to the upper end 85A of the housing member 20. More specifically, in the upright position for housing 20, the chamber 50 is preferably gradually tapered, both laterally and in front-to-back depth, to a more narrowed restricted spatial area as it extends upwardly to the upper end 85A of the housing 20, which upper end 85A should preferably, but not necessarily, be the uppermost part of the chamber 50 when the housing 20 is in the upright position discussed above. This progressive narrowing of the inner hollow chamber 50 is not critical, however, it is preferable to help funnel the upwardly flow of air to increase both the velocity and volume of the upward air flow towards air outlet opening 115. In this latter aspect it is preferable that this progressive narrowing of the chamber 50 be directed towards the upper air outlet opening 115, as seen in FIGS. 1, 2 and 3 so that all the rising flow of air will be directed to vent through such upper outlet 115 opening to the outside and flow directly against rotor 150. The purpose of this aspect is to increase the speed of the rising air flow and direct all such resultant air flow from air outlet opening 115 onto a limited part of the rotor mechanism. Since the rotor member 150 is mounted on a shaft that is preferably, but not essentially perpendicular to the back wall portion 70 of housing 20 and thus such resultant air flow is directed substantially perpendicular to the longitudinal axis of the rotor mechanism 150, as schematically shown in the drawings.

In the one embodiment of the subject invention, the air outlet opening 115 is positioned to direct all resultant air flow from chamber 50 onto the rotor blades 170A, 170B, 170C and 170D towards the bottom of such rotor blades and not frontally. However, because of the aerodynamic structures and positioning of the rotor blades 170A, 170B, 170C and 170D, the air flow impact from the outlet opening will propel the rotor blades only minimally. It is therefore preferable to direct the flow of the air upwardly onto a separate portion of the rotor 150 away from the rotor blades 170A, 170B, 170C and 170D. For this purpose, the rotor 150 can be equipped and structured with one or more flat, paddle-wheel like rotor blades preferably that are structured to receive efficiently the air upward flow of air as in a turbine arrangement of a paddle-wheel arrangement. For this purpose, air turbine blades 210A, 210B, 210C and 210D, 210E all affixed on their radically inner ends to the rotor member 150 are shown as flat blade members to receive the impact of air over such blades in a paddle-wheel arrangement to impel against the blades and rotate the rotor 150 in either a clockwise or counterclockwise manner, all independently of any movement of the rotor generated from the thrust of air directly over blades 170A, 170B, 170C, and 170D. For efficiency in this regard, it is preferable to position the air outlet opening 115 so that the upward thrust of air from such opening is projected over only one side of the rotor, so as to impinge only on the turbine blades 210A, 210B, 210C and 210D disposed either to the left or right of the central axis of rotor 150, as seen in FIG. 1. By this positioning the rotor 150 will be forced to rotate clockwise or counterclockwise depending on which side of the rotor the air outlet opening is positioned. This aspect should be consistent the direction of rotation of rotor 150 generated by rotor blades 170A, 170B, 170C and 170D.

As further seen from the frontal view in FIG. 4 in such embodiment, the wall 300 within chamber 50 is curved as it extends from its bottom end 305 toward the upper end 310 of the housing 20, however it can be straight as observed from such view. More particularly the wall 300 is directed towards the left side wall 80A of the housing 20, but within the internal spatial area 50 of the housing and in the embodiment shown in the drawings the upper end 310 of the internal wall 300 is abruptly terminated first beneath the position of the rotor member 350 as seen in the drawings of the rotor. The most narrow part of the chamber 50 is at that portion of the housing 20 just immediately adjacent or beneath the position of the left side of the rotor mechanism 350, as seen from the vantage point of FIG. 4. As stated, at this point the internal chamber 50 terminates into an air flow passage 360 that ejects the air flowing up through the chamber 50 from the air intake 90 into the spatial area where the rotor member is located. As seen the air outlet opening 360 is positioned so that the emitted upward air flow is directed towards only one side of the rotor mechanism 350. Alternatively stated in this embodiment of the subject invention the air ejected from the chamber 50 through the air flow passage 360 is directed by the existence of the narrowed portion to flow over the left portion only of the rotor member 350. By this latter arrangement air flowing out of the chamber 50 will impinge against the rotor blades of rotor member 350 in position on the left side of the rotor to move the blades clockwise, and will maintain this so impinging effect with continued flow against the rotor blades then dynamically positioned on the left side of the rotor and thence in succession against the next set of blades that move clockwise into position on the left side of the rotor. This restricted air flow pattern will keep air from impinging against the rotor blades on the right side of the rotor so as to prevent a net effect of the air flow pushing upward on all the positioned rotor blades on the right side and left side of the rotor 360 which could interfere with the clockwise movement of the rotor-as air impinging on the blades dynamically positioned on the right side of the rotor would cause the rotor to move counterclockwise. This latter effect is important as the front rotor blades, like those on rotor 150 in the first described embodiment project out beyond the housing 20 into the open air to receive outside air directed against the rotor. The front of rotor 350 projects outwardly from the front of the housing to receive also the direct impact of the wind. An alternate arrangement the rotor could be position it parallel to the back wall portion of the housing to face the blades head on relative to the upward flow of air.

Once the air flow impinges against the rotor blades it is ejected through an outlet opening 360 on housing 20 or the resultant spent air may be directed downwardly through the spatial area 400 in housing 20 that is formed to the right in chamber 50 and to the left of the wall 300 is placed in the housing. As seen this remaining spatial area 400 to the right of the chamber 50 can lead back to the area just adjacent into the air inlet opening 90. To recirculate the air through chamber 50, a vacuum pump may be used to help this process, not shown.

In all embodiments therein the rotor member inside the housing is structured to be rotatable, as driven by the rising air inside the chamber, as more specifically discussed above, with the central concept being that air that is drawn up through the chamber 50, it will be heated by solar heat energy passing through the translucent front wall 60 which solar energy will heat the air rising through the chamber 50 such solar heating being enhanced by the dark surface or the posterior wall 70 of the housing 20. More specifically as the air is heated it rises through the chamber 50 it will become heated and rise at a more forcible rate and greater velocity so that the resultant air flow will have a greater impact against the blades and rotors on the rotor member 160 or rotor member 350. As stated above, in order to facilitate and otherwise accelerate the upward flow of air in the chamber 50, the chamber is structured to be increasingly narrowed and constricted so that the rising air as it is heated in the chamber will be heated by solar rays entering the chamber through the front translucent surface 60. Thus, as the air is heated, by solar energy, it will rise at yet a more increasingly faster rate in restricted space in its upwardly movement.

As stated in one embodiment, only the back surface 70 of the chamber 50 is coated with a dark material so that the solar absorption process is enhanced only in the chamber 50 portion. Moreover, in another embodiment, the back surface of the chamber 50 which is solar absorptive may be equipped with suitable solar cells or other means to convert the impacted heat thereon to electrical energy to supplement the power generated by the air driven rotor.

As can be further seen in alternative embodiments, the rotor member 150 or 350 can be affixed in the housing member 20 is thus exposed in part to the frontal flow of wind in addition to the upper flow of wind from inside the chamber 50. The rotor shaft will thus be driven by two air flow force components. First, the oncoming head wind will drive the rotor, as in the case of an ordinary windmill, and airflow in chamber 50 will also impinge the rotor blades on one side as discussed above. This will provide two separate air movement components for the rotor movement.

In implementing this invention it is important to focus on the effect of heated air to rise upwardly particularly on the sides of mountains and large solid structures. This combined solar wind effect on mountain sides during day time hours can be capitalized using in the subject invention. For instance, if the subject apparatus 10, with attendant housing 20 were placed upright along the side of a mountain the normal upwind air flow from the base of the mountain can be directed into the air through the air inlet opening 90 of the apparatus 10 to flow upwardly through chamber 50 to impel the rotor. In such situation, the rotor can also be exposed to the frontal wind as stated above. On the other hand, the rotor may be covered and not exposed at all to outside air, as suggested in part by FIG. 3. If such a device is placed along said mountain or structure it would need to be significantly high, or long enough to capture as much solar energy as possible in the upper rise of the air in Chamber 50. For this purpose a heights of 100 feet or more would be optimal but lesser or greater heights could be used. However, it is not critical to the subject invention to place the device near a mountain nor is it necessary to structure it to a substantial height, as it can be of any length or height.

In summary, the subject invention is a structure for harnessing sun generated air currents to drive a rotor mechanism comprising:
(a) a housing member having a frontal surface and a rear surface, such housing member having an internal chamber within such housing member, with such housing member having a translucent cover on such frontal surface, to admit sunlight into such chamber, and wherein such housing member has an air inlet opening and an air outlet opening, such inlet opening and such air outlet opening extending between such internal chamber and outside such housing, rotor means affixed adjacent to such air outlet opening to receive the air flow from such air outlet opening for driving such rotor.

Another summary is that the subject invention is a structure for harnessing air currents to drive a rotor mechanism comprising:
(a) a housing member having an outer surface, such housing member having an internal chamber with such housing member having a frontal wall comprising the enclosure to such chamber, with such frontal wall having a portion thereof which is translucent for admission of sunlight into such chamber, such housing member having an air inlet opening leading from spatial areas outside such housing member to spatial areas inside said chamber of such housing member;
(b) air outlet means on such housing member, such air outlet means extending from areas inside such chamber to spatial areas outside such chamber;
(c) air-driven rotor member having a central rotatable axle affixed to a position adjacent such air outlet means, such rotor-driven member having a rotor blade affixed to a portion of such rotatable axle for receiving incoming wind and wherein such rotor means has additional rotor blades to receive the impact of air escaping from such chamber in such housing.

Furthermore, the subject invention can be summarized as a combined solar powered and wind powered rotor mechanism comprising
(a) a housing member, such housing member having an internal longitudinally extending chamber, disposed with side such housing member, and wherein such housing member has an air inlet opening therein which extends from spatial areas outside such housing into such chamber, and wherein such housing has an air outlet opening to vent aid from such chamber;
(b) a rotor mechanism having a plurality of vane members to receive the impact of air vented from such air outlet opening and drive said rotor mechanism.

In further summary, the subject invention is a rotor apparatus structured to be driven by wind force and solar energy comprising:
(a) a housing member with an internal chamber with an upper portion and a lower portion, said housing member having a translucent front surface portion on the outside of solar chamber and a solar absorptive back surface portion with a solar energy collector chamber within such housing, with such chamber being disposed between such front surface portion and such back surface portion, such housing member having an air intake opening on the lower portion of such housing, which air intake opening leads to the solar energy collection chamber, such housing having an air outlet opening that emits passing air from the solar energy collection chamber, and further comprising;
(b) rotatable shaft means rotatably mounted through such housing member with a portion of such shaft projecting out from the front of such housing and a portion of such shaft passing through the solar absorption chamber, and further comprising;
(c) wind driven rotor means disposed concentricity on that portion of the rotatable shaft that projects frontally of the front surface, and further comprising;
(d) air driven means disposed on that portion of the rotor shaft in the chamber.

1: A structure for harnessing sun generated air currents to drive a rotor mechanism comprising:
(a) a housing member having a frontal surface and a rear surface, said housing member having an internal chamber within said housing member, with said housing member having a translucent cover on said frontal surface to admit sunlight into said chamber, and wherein said housing member has an air inlet opening and an air outlet opening, said inlet opening and said air outlet opening extending between said internal chamber and outside said housing;
(b) rotor means affixed adjacent to said air outlet opening to receive the air flow from said air outlet opening from said chamber.

2: A structure for harnessing air currents to drive a rotor mechanism comprising:
(a) a housing member having an outer surface, said housing member having an internal chamber with said housing member having a frontal wall comprising the enclosure to said chamber, with said frontal wall having a portion thereof which is translucent for admission of sunlight into said chamber, said housing member having an air inlet opening leading from spatial areas outside said housing member to spatial areas inside said chamber of said housing member;
(b) air outlet means on said housing member, said air outlet means extending from areas inside said chamber to spatial areas outside said chamber;
(c) air-driven rotor member having a central rotatable axle affixed to a position adjacent said air outlet means, said rotor-driven member having a rotor blade affixed to a portion of said rotatable axle for receiving incoming wind and wherein said rotor means has additional rotor blades to receive the impact of air escaping from said chamber in said housing.

3: A combined solar powered and wind powered rotor mechanism comprising
(a) a housing member, said housing member having an internal longitudinally extending chamber, disposed with side said housing member, and wherein said housing member has an air inlet opening therein which extends from spatial areas outside said housing into said chamber, and wherein said housing has an air outlet opening to vent air from said chamber;
(b) a rotor mechanism having a plurality of vane members to receive the impact of air vented from said air outlet opening and drive said rotor mechanism.

4: The subject invention is a rotor apparatus structured to be driven by wind force and solar energy comprising:
(a) a housing member with an internal chamber with an upper portion and a lower portion, said housing member having a translucent front surface portion on the outside of solar chamber and a solar absorptive back surface portion with a solar energy collector chamber within said housing, with said chamber being disposed between such front surface portion and such back surface portion, said housing member having an air intake opening on the lower portion of said housing, which air intake opening leads to the solar energy collection chamber, said housing having an air outlet opening that emits passing air from the solar energy collection chamber, and further comprising;
(b) rotatable shaft means rotatably mounted through said housing member with a portion of such shaft projecting out from the front of said housing and a portion of said shaft passing through the solar absorption chamber, and further comprising;
(c) wind driven rotor means disposed concentricity on that portion of the rotatable shaft that projects frontally of the front surface, and further comprising;
(d) air driven means disposed on that portion of the rotor shaft in the chamber.

5: A structure for utilizing air currents to drive a rotor mechanism comprising:
(a) a housing member having an internal chamber formed in part by a first outer surface on said housing and a second outer surface on said housing, and wherein said first outer surface is translucent to admit sunlight through said first outer surface to said internal chamber and wherein said housing member has an air inlet opening to admit external air from spatial areas outside said internal chamber into said internal chamber, and an air outlet opening to emit air from said internal chamber to spatial areas outside said chamber;
(b) air-driven rotor member having a central rotatable axle affixed to a position adjacent said air outlet opening, said rotor member having a set of rotor blades affixed to a portion of said rotatable axle for receiving incoming wind from spatial areas outside said chamber and wherein said rotatable axle has a second set of rotor blades to receive the impact of air escaping from said internal chamber in said housing through said air outlet opening.

6: A structure for utilizing heat generated air currents and wind power to drive a rotor mechanism comprising:
(a) a housing member having a first outer surface and a second outer surface member having an internal chamber adjacent said first outer surface within said housing member, with said first surface being translucent to admit sunlight into said chamber, and wherein said housing member has an air inlet opening and an air outlet opening, said air inlet opening and said air outlet opening both extending between said internal chamber and spatial areas outside said housing;
(b) first air movement sensitive rotor means affixed on a rotor shaft movement adjacent to said air outlet opening to receive the air flow emitted from said air outlet opening from said chamber for rotating said rotor shaft;
(c) second air movement rotor means affixed to said rotor shaft to be driven by wind currents from outside said housing member.

7: A structure for utilizing heat generated air currents and wind power to drive a rotor mechanism comprising:
(a) a housing member having an internal chamber formed in part by a first outer surface on said housing and a second outer surface on said housing, and wherein said first outer surface is translucent to admit sunlight through said first outer surface to said internal chamber and wherein said housing member has an air inlet opening to admit external air from spatial area outside said chamber into said chamber, and an air outlet opening to eject air from said internal chamber.
(b) first air movement sensitive rotor means affixed on a rotor shaft movement adjacent to said air outlet opening to receive the air flow emitted from said air outlet opening from said chamber for rotating said rotor shaft;
(c) second air movement rotor means affixed to said rotor shaft to be driven by wind currents from outside said housing member;
